(19) United States
(12) Patent Application Publication
(10) Pub. No.: US 2012/0127706 A1
(43) Pub. Date: May 24, 2012

(54) SLIM LED LIGHT

(76) Inventors: Jish-Shyan Jiang, Xizhi City (TW); Shih-Chen Lu, Taipei City (TW); Chang-Jui Lin, Xizhi City (TW)

(21) Appl. No.: 12/949,400

(22) Filed: Nov. 18, 2010

(51) Int. Cl. F21V 29/00; F21V 21/00

(52) U.S. Cl. 362/218; 362/217.17

(57) ABSTRACT

A slim LED light includes an LED package substrate, two electrically conductive elements, and an extraction seat having a first light holder main body, a second light holder main body and a connection member integrally connected between the first and second light holder main bodies. The first light holder main body has at least one insertion slot as a first insertion slot. The second light holder main body has at least one insertion slot as a first insertion slot corresponding to the insertion slot of the first light holder main body. The LED package substrate can be inserted into/extracted out of the cooperative first insertion slots of the first and second light holder main bodies. When fully inserted into the first insertion slots, the LED package substrate is electrically connected with the electrically conductive elements. The LED package substrate can be easily replaceably installed on the extraction seat.

### BACKGROUND OF THE INVENTION

1. Field of the Invention

The present invention relates generally to an LED light, and more particularly to a slim LED light in which the components can be easily installed and replaced.

2. Description of the Related Art

It is known that various light sources play very important roles in our daily lives. These light sources provide illumination inside and outside all kinds of buildings. A fluorescent lamp is one of the most often seen light sources. In order to achieve better light scattering effect, the fluorescent lamp is generally installed in a relatively high position, (such as under a ceiling). The fluorescent lamp emits light by means of gas discharge. The electrons in the fluorescent lamp are accelerated to make the gas enclosed therein emit ultraviolet rays. The ultraviolet rays pass through fluorescent powder coated on the glass lamp tube to make the fluorescent lamp emit light. In general, the mercury contained in the glass lamp tube will be totally absorbed by the tube wall after about 6000-hour use of the fluorescent lamp. In this case, the fluorescent lamp will lose its discharge capability and may burn out. At this time, it is often necessary to use a ladder for uninstalling and replacing the damaged lamp tube. This is quite inconvenient.

Recently, various light-emitting diodes (LEDs) have been developed to replace the conventional fluorescent lamp that is defective in short lifetime and great power consumption. The LED is advantageous over the conventional fluorescent lamp in that it has longer lifetime, consumes lower power and is ultraviolet-free. Therefore, it is unnecessary to frequently replace the LED.

FIG. 1 shows a conventional LED light structure 10, which has a light main body 11 and an LED package substrate 12. Multiple radiating fins 13 are formed on a rear side of the light main body 11. When an LED chip emits light and generates high heat at the same time, the radiating fins 13 serve to conduct and dissipate the heat to lower the temperature. However, such LED light structure 10 has some shortcomings that need to be improved as follows: First, the LED light structure 10 has a quite large volume and necessitates larger room in storage or transfer. This fails to catch up the trend to slim the product in the market. Second, the LED package substrate 12 is positioned in the light main body 11. As a result, it is inconvenient to install/replace the LED package substrate 12.

### SUMMARY OF THE INVENTION

A primary object of the present invention is to provide a slim LED light having simplified and slimmed structure.

A further object of the present invention is to provide the above slim LED light in which the components can be easily installed and replaced.

To achieve the above and other objects, the slim LED light of the present invention includes an LED package substrate, two electrically conductive elements, and an extraction seat. The extraction seat has a first light holder main body, a second light holder main body and a connection member connected between the first and second light holder main bodies for integrally connecting the first and second light holder main bodies with each other. The first light holder main body has at least one insertion slot as a first insertion slot.

The second light holder main body has at least one insertion slot as a first insertion slot corresponding to the insertion slot of the first light holder main body. The LED package substrate can be inserted into/extracted out of the cooperative first insertion slots of the first and second light holder main bodies. When the LED package substrate is fully inserted into the first insertion slots, the LED package substrate is electrically connected with the electrically conductive elements. The LED package substrate can be easily replaceably installed on the extraction seat.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional view of a conventional LED light structure;

FIG. 2 is a perspective assembled view of the slim LED light of the present invention;

FIG. 3 is a sectional view taken along line 3-3 of FIG. 2;

FIG. 4 is a perspective exploded view of the slim LED light of the present invention;

FIG. 5 is a sectional view taken along line 5-5 of FIG. 2; and

FIG. 6 is a sectional view taken along line 6-6 of FIG. 4, showing the extraction seats of the slim LED light of the present invention.

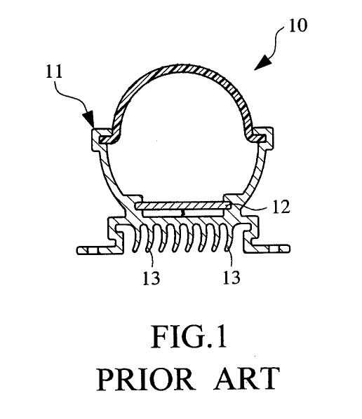

### DETAILED DESCRIPTION OF THE PREFERRED EMBODIMENT

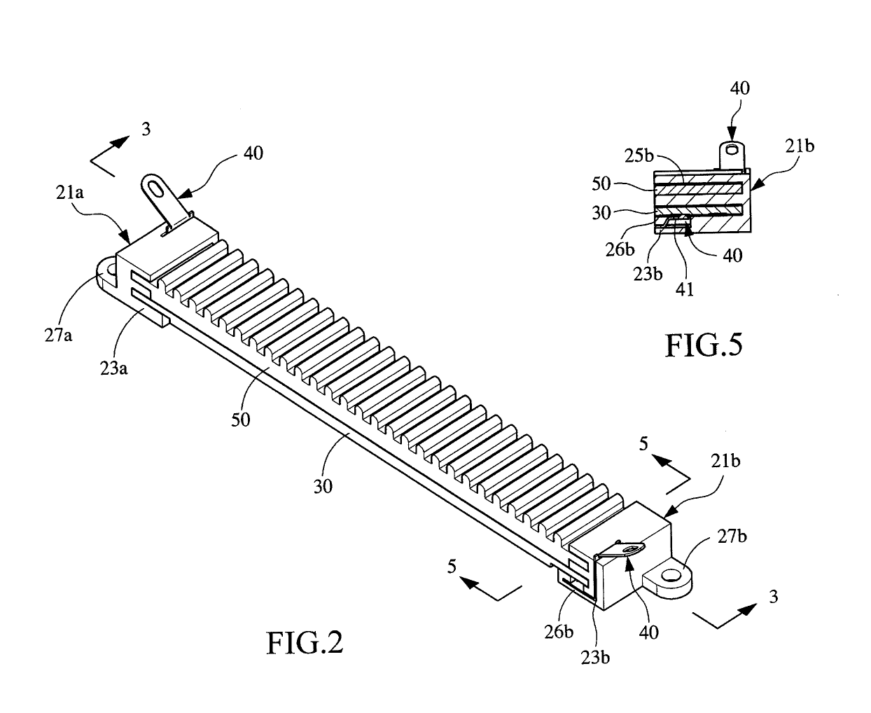

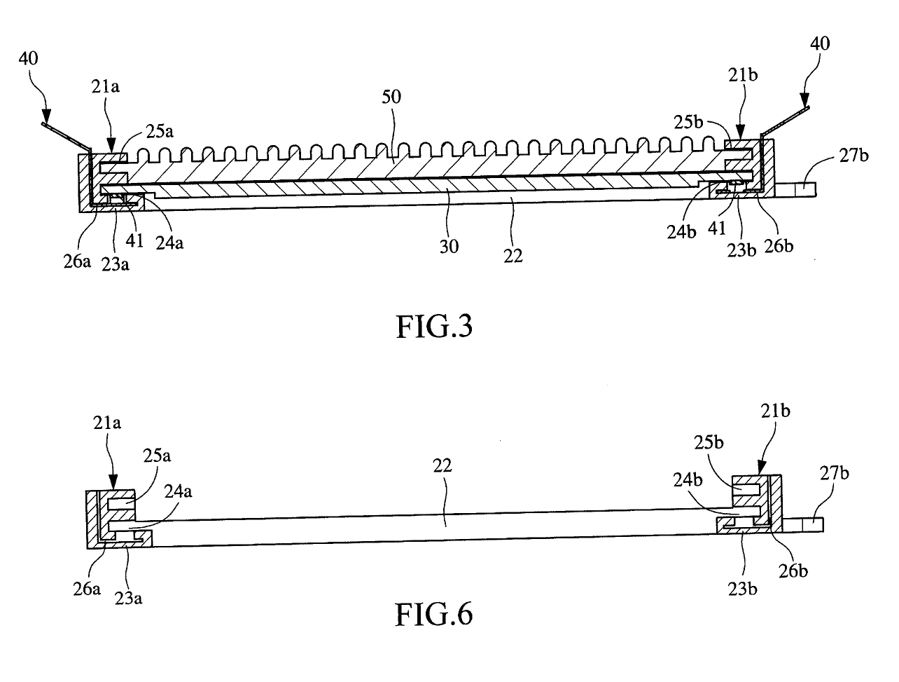

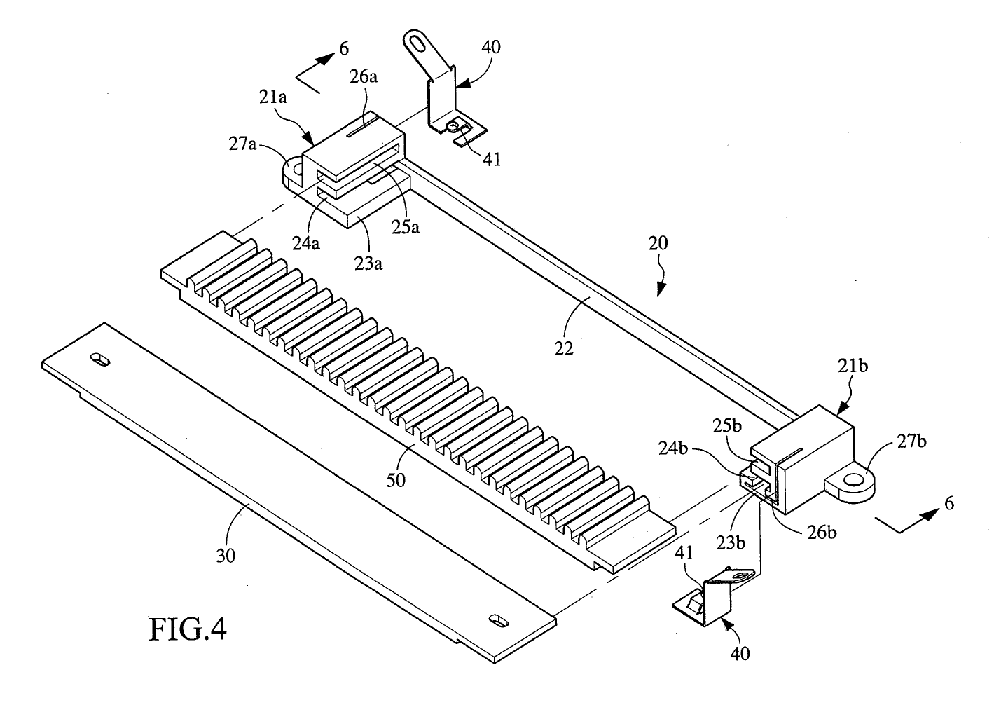

Please refer to FIGS. 2 to 5. The slim LED light of the present invention includes an extraction seat 20, an LED package substrate 30 and two electrically conductive elements 40. As shown in FIG. 6, the extraction seat 20 has a first light holder main body 21a, a second light holder main body 21b and a connection member 22 connected between the first and second light holder main bodies 21a, 21b for integrally connecting the first and second light holder main bodies 21a, 21b with each other. The first light holder main body 21a has a base seat 23a and at least one transverse insertion slot. In this embodiment, the first light holder main body 21a has two transverse insertion slots for illustration purposes only. That is, the first light holder main body 21a has a first transverse insertion slot 24a and a second transverse insertion slot 25a. The second light holder main body 21b has a base seat 23b and at least one transverse insertion slot. The number of the transverse insertion slots is equal to that of the first light holder main body 21a. That is, the second light holder main body 21b has a first transverse insertion slot 24b corresponding to the first transverse insertion slot 24a of the first light holder main body 21a, and a second transverse insertion slot 25b corresponding to the second transverse insertion slot 25a of the first light holder main body 21a. The LED package substrate 30 can be inserted into/extracted out of the cooperative first insertion slots 24a, 24b of the first and second light holder main bodies 21a, 21b. When the LED package substrate 30 is fully inserted into the first insertion slots 24a, 24b, the LED package substrate 30 is electrically connected with the electrically conductive elements 40.

The base seats 23a, 23b of the first and second light holder main bodies 21a, 21b respectively have two reception slits 26a, 26b for receiving the electrically conductive elements 40 therein. In practice, the reception slits 26a, 26b are L-shaped, each having a transverse section in communication with the first insertion slot 24a, 24b. In practice, the electrically conductive elements 40 are plate-like structures each having a contact section 41. The electrically conductive elements 40 can be inserted into/extracted out of the reception slits 26a, 26b of the first and second light holder main bodies 21a, 21b. Accordingly, the LED package substrate 30 can be electrically connected with the contact sections 41 of the electrically conductive elements 40.

A heat dissipation plate 50 can be inserted into/extracted out of the cooperative second insertion slots 25a, 25b of the first and second light holder main bodies 21a, 21b. When the LED chip mounted on the LED package substrate 30 continuously emits light and generates high heat at the same time, the heat dissipation plate 50 serves to conduct and dissipate the heat to the ambient air so as to lower the temperature. This avoids decrease of light power of the LED chip due to overheating.

The first and second light holder main bodies 21a, 21b respectively have two fixing lugs 27a, 27b, which outward extend from outer wall faces of the first and second light holder main bodies 21a, 21b. By means of the fixing lugs 27a, 27b, the slim LED light of the present invention can be affixed to a plane face such as a ceiling, an advertisement sign or the like as an illuminator.

The LED package substrate 30, the electrically conductive elements 40 and the heat dissipation plate 50 can be DIY (Do It Yourself) installed on and assembled with the extraction seat 20 to form the slim LED light of the present invention. In case the LED package substrate 30 is damaged, it can be easily replaced.

In conclusion, the LED light of the present invention has a slim structure and the LED package substrate 30, the electrically conductive elements 40 and the heat dissipation plate 50 can be connected with or disconnected from the extraction seat 20 in an insertion/extraction manner. Accordingly, it is easy and convenient to assemble or replace the components of the slim LED light of the present invention.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. A slim LED light comprising:
an LED package substrate;
two electrically conductive elements; and
an extraction seat having a first light holder main body, a second light holder main body and a connection member connected between the first and second light holder main bodies for integrally connecting the first and second light holder main bodies with each other, the first light holder main body having at least one insertion slot as a first insertion slot, the second light holder main body having at least one insertion slot as a first insertion slot corresponding to the insertion slot of the first light holder main body, whereby the LED package substrate can be inserted into/extracted out of the cooperative first insertion slots of the first and second light holder main bodies, when the LED package substrate is fully inserted into the first insertion slots, the LED package substrate being electrically connected with the electrically conductive elements.

2. The slim LED light as claimed in claim 1, wherein the first light holder main body further has a second insertion slot and the second light holder main body further has a second insertion slot corresponding to the second insertion slot of the first light holder main body, whereby a heat dissipation plate can be inserted into/extracted out of the cooperative second insertion slots of the first and second light holder main bodies for conducting and dissipating heat.

3. The slim LED light as claimed in claim 1, wherein each electrically conductive element has a contact section for electrically connecting with the LED package substrate.

4. The slim LED light as claimed in claim 1, wherein the first and second light holder main bodies respectively have two base seats, each base seat being formed with a reception slit in communication with the first insertion slot for receiving the electrically conductive element therein.

5. The slim LED light as claimed in claim 1, wherein the reception slits are L-shaped.

6. The slim LED light as claimed in claim 1, wherein the first and second light holder main bodies respectively have two fixing lugs, which outward extend from outer wall faces of the first and second light holder main bodies.
